(19) United States
(12) Patent Application Publication
(10) Pub. No.: US 2010/0042915 A1
(43) Pub. Date: Feb. 18, 2010

(54) Personalized Document Creation

(76) Inventors: Setsuo Ohara, Irvine, CA (US); Faisal Altoukhy, Irvine, CA (US); Frank Perdicaro, Fountain Valley, CA (US)

Correspondence Address: SoCAL IP LAW GROUP LLP, 310 N. WESTLAKE BLVD. STE 120, WESTLAKE VILLAGE, CA, 91362, US

(21) Appl. No.: 12/190,506

(22) Filed: Aug. 12, 2008

(51) Int. Cl. G06F 17/00

(52) U.S. Cl. 715/243

(57) ABSTRACT

There is disclosed environments, systems and processes for personalized document creation. Custom fixed documents may be obtained from XPS-formatted document templates based upon customization information. Document templates may be created and related to variable content in a content database. A rendering system may use the customization information in merging a selected document template with the content database in accordance with relationships and selection criteria.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to printing of documents incorporating variable data.

2. Description of the Related Art

The XML Paper Specification version 1.0 (XPS) was created by Microsoft Corp. to provide users and developers with a robust, open and trustworthy format for electronic paper. Design goals for XPS included better document printing, easier document sharing, more document security, and reliable document archiving.

The XPS “Document” format (as contrasted with XPS-formatted documents themselves) describes a paginated representation of electronic paper that is described by XPS' XML-based page description language. Thus, XPS-formatted documents can be open and cross-platform, allowing users to easily generate, share, print, and archive paginated documents.

An important aspect of XPS-formatted documents is that they are “fixed” documents rather than “flow” documents. A flow document can change appearance depending on how or where it is viewed. For example, a Web page is often a flow document. In contrast, a fixed document does not change appearance or layout after it is published. For example, a printed document is a fixed document because its appearance does not change. The content of a fixed document is not intended to be modified, although some document attributes and properties, such as digital signatures, can be added or modified. For example, a document in Adobe pdf format may be fixed.

XPS itself is platform independent, openly published, and available royalty-free. Microsoft has integrated XPS-based technologies into the Microsoft Windows Vista operating system and the 2007 Microsoft Office system.

Through XPS technology, it was intended that applications could be seamlessly integrated with enterprise-wide workflows by adding the ability to publish, import, and view XPS-formatted documents. Microsoft reports that its .NET Framework 3.0 provides APIs that enable developers to add XPS-based publishing, importing, and viewing technologies to Windows Presentation Foundation (WPF) applications. Adding XPS-based technologies to an application is said to give users a print quality that was previously found only in high-end graphic arts applications.

An XPS-formatted document is a page-by-page view of the document's content as it would be printed. The XPS-formatted document format provides a safe and secure way to store and share an electronic document. The layout of the content is fixed and does not contain any arbitrary code, macros, or scripts. XPS-formatted documents include built-in support for digital signatures and can be protected by using rights management applications that use Windows Rights Management System (RMS). These features provide a stable, secure, and reliable document platform and make XPS-formatted documents well-suited for applications that require accurate presentation of the document's contents, adherence to data governance, protection of sensitive information, or long-term document storage.

The XPS Document format is a component of the WPF, which is a presentation subsystem that unifies a range of output services, including user interface, media, and documents. The WPF provides a single, managed-code framework for these services. Documents in XPS Document format distill WPF elements into a fixed, printable, and portable format allowing applications to share documents for collaboration across multiple machines without requiring the original application to be installed on those machines.

The XPS Document APIs generally support either reading the content of an XPS-formatted document or writing application content to an XPS-formatted document, but the APIs do not support modifying the content of an existing XPS-formatted document. The fact that the XPS Document APIs do not directly support document modification does not mean that users cannot edit their XPS-formatted documents. Instead it means that the process of modifying an XPS-formatted document is to create a new document and leave the original document intact.

The XPS Document format consists of structured XML markup that defines the layout of a document and the visual appearance of each page, along with rendering rules for distributing, archiving, rendering, processing and printing the document. The markup language for XPS is a subset of Extensible Application Markup Language (XAML), allowing it to incorporate vector-graphic elements in documents, using XAML to mark up the WPF primitives. The elements used are described in terms of paths and other geometrical primitives.

The term markup refers to annotations to text that describe how the text is to be structured, laid out, or formatted. A markup language may also provide for image markup. Markup languages typically intermix the text of a document with markup instructions in the same data stream or file. This is not necessary; it is possible to isolate markup from text content, using pointers, offsets, IDs, or other methods to co-ordinate the two.

An XPS-formatted document file is actually a ZIP (i.e., a file format for lossless data compression) archive using the Open Packaging Convention, which contains the files which make up the document. These include an XML markup file for each page, text, embedded fonts, raster images, 2D vector graphics, as well as digital rights management information. The contents of an XPS file can be examined simply by opening it in an application which supports ZIP files.

One feature of XPS is called “Stories”. An XPS story in an XPS-formatted document is roughly analogous to a story in a newspaper or magazine. It is a passage of one or both of text and graphic content, usually on a single topic, within a single XPS-formatted document. Typically, it spans multiple pages, but it can be shorter than a page like a sidebar/boxed story in a magazine. A Story can also be discontinuous like a front page newspaper story that is continued on a later page. Consequently, a given page can have more than one Story and parts of more than one Story. A header or footer is also a special kind of Story that is entirely contained on a single page. There is no limit to the number of XPS files that can contain a single Story. A Story can be in a single document in an XPS file, or spread across multiple documents in an XPS. (Any subset of the documents in an XPS, in the strict mathematical sense of set, including the null set and the whole set.) A single story can be spread across multiple XPS files in the same way. This is the classic concept of serialization, where a single story is spread across multiple printed documents.

A “StoryFragment” represents all or a portion of a Story. It can never span more than one page, but it can occupy the whole of a page or share a page with other fragments. If a Story is on more than one page, each part of it on each page is a separate fragment. Although Stories can have discontinuous sets of fragments, no fragment can itself be discontinuous.

### DESCRIPTION OF THE DRAWINGS

FIG. 1 is a diagram of a computing environment for personalized document creation.

FIG. 2 is a functional block diagram of a system for personalized document creation.

FIG. 3 is a flowchart of a process for personalized document creation.

FIG. 4 is sample of an XPS-formatted document template.

FIG. 5 is the appearance of the document template of FIG. 4.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously-described element having a reference designator with the same least significant digits.

### DETAILED DESCRIPTION

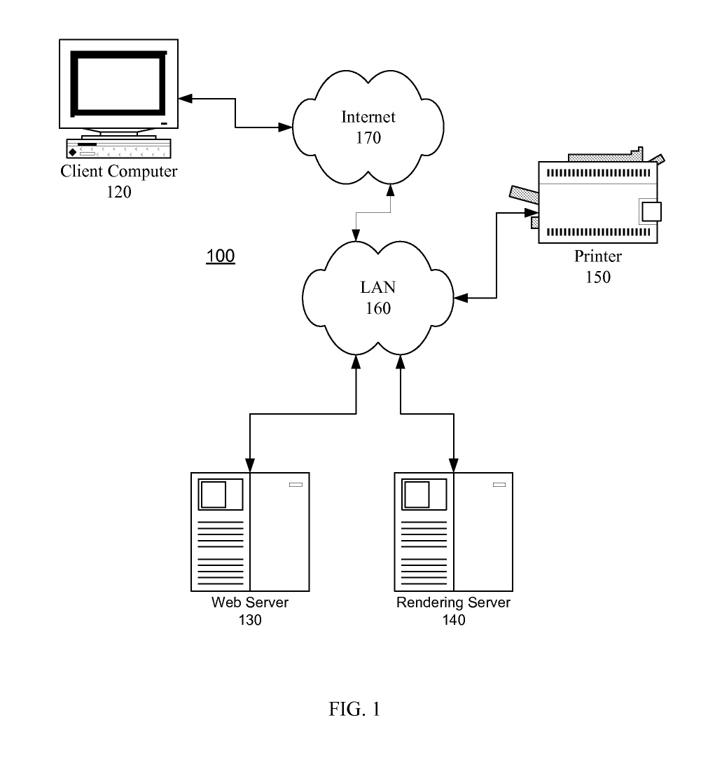

Referring now to FIG. 1 there is shown a diagram of a computing environment 100 for personalized document creation. In this environment, custom, fixed documents may be rendered from document templates having static content and variable content. By “content”, it is meant text and images that become user-perceptible in a document when the document is displayed or printed. Static content in a document is content which is always the same in the document. Variable content is content in a document which varies. If the document template is XPS, then one or both of the static content and variable content may be defined in the document template with markup, and the content itself may come from a source outside of the document template.

The computing environment includes a client computer 120, a web server 130, a rendering server 140, and a printer 150. The web server 130, the rendering server 140 and the printer 150 are interconnected by a local area network (LAN) 160. The client computer 120 is connected to the Internet 170 which is connected to the LAN 160.

The client computer 120 may be a personal computer (PC) with a web browser. In general, multiple client computers will be used for varied user-based tasks such as end-user inputs of characteristics which impact variable data documents, laying out documents, creating variable data for the documents, managing the web server 130, managing the rendering server 140, managing the printer 150, etc. as well as for activities typically performed on a PC, such as sending email and browsing web sites.

The web server 130 may be a server that hosts a web site accessible from web browsers, e.g., by the client computer 120.

The rendering server 140 may be a server for rendering documents to be printed on the printer 150.

The printer 150 may be a commercial-class system, providing high volume and high quality output, such as those used for brochures.

The client 120 computer, the web server 130 and the rendering server 140 may include software and/or hardware for providing the functionality and features described herein. The systems 120, 130, 140 may therefore include one or more of: logic arrays, memories, analog circuits, digital circuits, software, firmware, and processors such as microprocessors, field programmable gate arrays (FPGAs), application specific integrated circuits (ASICs), programmable logic devices (PLDs) and programmable logic arrays (PLAs). The hardware and firmware components of the client computer 120, the web server 130 and the rendering server 140 may include various specialized units, circuits, software and interfaces for providing the functionality and features described here. The processes, functionality and features may be embodied in whole or in part in software and may be in the form of one or more of firmware, an application program, an applet (e.g., a Java applet), a browser plug-in, a COM object, a dynamic linked library (DLL), a script, one or more subroutines, or an operating system component or service. The hardware and software and their functions may be distributed amongst the client computer 120, the web server 130, the rendering server 140 and the printer 150.

Although shown implemented in unitary devices, the processes and apparatus of the client computer 120, the web server 130, the rendering server 140 and the printer 150 may be implemented as component systems, distributed systems, or other forms of computing devices. Appropriate computing devices include a processor, memory and a storage device that may execute instructions including, but not limited to, personal computers, server computers, computing tablets, set top boxes, video game systems, personal video recorders, telephones, personal digital assistants (PDAs), portable computers, and laptop computers. These computing devices may run an operating system, including, for example, variations of the Linux, Microsoft Windows, Symbian, and Apple Mac operating systems.

The techniques discussed herein may be implemented with storage media in a storage device included with or otherwise coupled or attached to a computing device. That is, the software may be stored in machine readable media. These storage media include, for example, magnetic media such as hard disks, floppy disks and tape; optical media such as compact disks (CD-ROM and CD-RW) and digital versatile disks (DVD and DVD±RW); flash memory cards; and other storage media. As used herein, a storage device is a device that allows for reading and/or writing to a storage medium. Storage devices include, hard disk drives, DVD drives, flash memory devices, and others.

Although only the LAN 160 and the Internet 170 are shown, the systems 120, 130, 140, 150 may be interconnected through a single or multiple networks and interconnects which may be separate or standalone. These networks and interconnections may be wired or wireless, public or private, local or wide area, etc. and combinations of all or some of these.

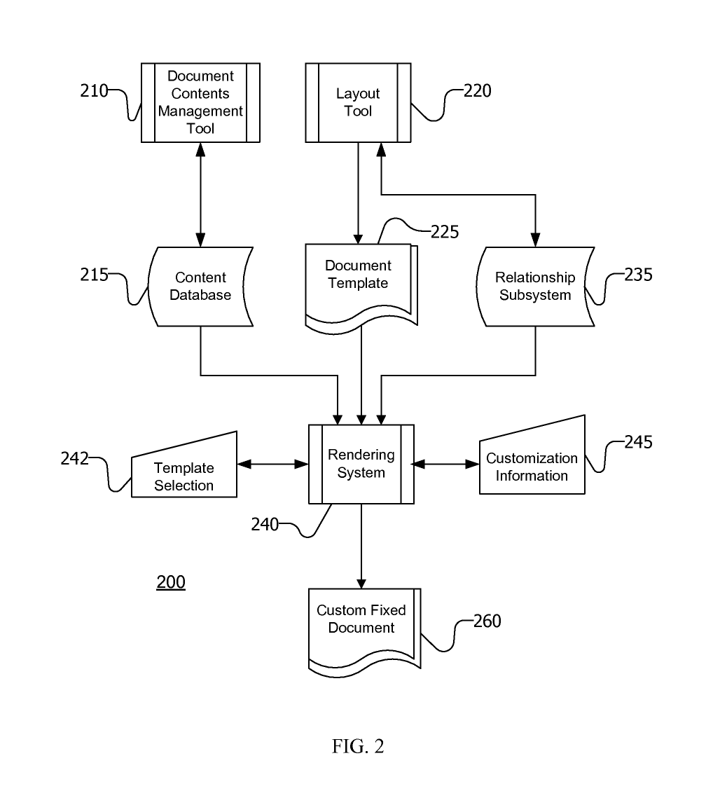

Referring now to FIG. 2 there is shown a functional block diagram of a system 200 for personalized document creation. The system 200 may be implemented in software, such as a stand-alone application, which resides in a rendering server such as the rendering server 140 (FIG. 1) and may be accessed by a user through a client computer such as the client computer 120 (FIG. 1). The personalized document creation system 200 includes a document contents management tool 210, a layout tool 220, a content database 215, a relationship subsystem 235, and a rendering system 240. Intermediate output of the system 200 may include content and other data in the content database 215, and one or more document templates 225. The system 200 may receive as input (e.g., user input) a template selection 242 and customization information 245. Final output of the system 200 may include custom fixed documents 260.

The document contents management tool 210 and the layout tool 220 can be client-server web-based applications or standalone applications. The document contents management tool 210 may be used to store in the content database 215 various text and images available for inclusion as variable content in the custom fixed documents 260. Keywords may be included in the content database 215 and the document contents management tool 210 may be used to create relations between the keywords on the one hand and stored text and images on the other hand. Instead of or in addition to full keywords, keys may be related to the text and images in the content database 215. Keywords may be related to the keys. Thus, the text and images may be retrieved using keywords or keys, depending on the database structure and contents, which may be set by the user using the document contents management tool 210. A keyword is a single word or short phrase which itself has meaning. Unlike a keyword, a key is merely representative of a characteristic without inherently describing or suggesting the characteristic. A key therefore may be a code which is substantially meaningless on its own, whereas a keyword is always meaningful. For convenience, the term keyword will be used herein to refer to both keywords and keys as alternates and in the collective. Based upon context it is expected that a limitation to keywords or keys will be recognizable.

The layout tool 220 may be used to create the document templates 225. This may include specifying what static content to include, and where and how the static content should appear. The layout tool 225 may also be used to define one or more stories within document templates in which variable content will appear, how the variable content will appear, and/or criteria for selecting the variable content. By story, it is meant a passage of one or both of text and graphic content, usually on a single topic, within a single document. A story may span multiple pages, but it can be shorter than one page, and may be discontinuous. A given page can have more than one story and parts of more than one story. XPS Stories are a form of story. The layout tool 220 may further be used to add formatting to the static content, the variable content, and/or other portions of the document template. The layout tool 220 may accomplish all this by putting appropriate markup in the document templates, such as XPS markup.

The document layouts may be saved in different forms. For one, a document template may be saved as an XPS file containing unexpanded (i.e., unresolved) keywords. Second, a document template may be saved as an XPS file containing only structure information (e.g., using XPS structure definition as described in Chapter 9 of the XPS 1.0 Specification), and a binary file containing unexpanded keyword data. Third, a document template may be saved in XML form, where an XML schema describes a template, and a corresponding or related binary file contains unexpanded keyword data.

The document templates 260 may be created or limited to be devoid of content and contain only structure. Since it might be desirable to have static content in the new, fixed document, the document templates may be marked up to receive static content.

The relationship subsystem 235 may store relationships between the document templates (i.e., markers in the document templates) and the criteria for selecting the variable content. This selection criteria may be algorithms using the keywords to search the content database 215. Alternatively, the selection criteria may correspond to a limited set of categories, and the keywords or the variable content itself may be related in the content database to the categories. These relationships may be defined using the layout tool 220 and then stored in the relationship subsystem 235 in conjunction with saving a respective document template. The stored relationships and the selection criteria, in effect, provide a bridge between the document templates 225 and the content database 215.

The rendering system 240 may produce the custom fixed documents 260, for example as XPS-formatted documents, based upon the customization information 245. The template selection 242 may identify which of the document templates 225 should be used by the rendering system 240. The rendering system 240 may use the customization information 245 in merging the selected document template with the content database 215 in accordance with the relationships and the selection criteria in the relationship subsystem 235, to thereby insert variable content into the stories in the selected document template. The rendering system 240 gives the final appearance to the custom fixed document 260 and puts it into a form suitable for printing.

In accordance with markup in the document template, reflow of marked up stories may be restricted or prevented. By reflow, it is meant that one or more of the position, size and/or formatting of the story within a page and across pages, is changed to adapt the story to other content within the document. Reflow typically occurs within a web page, for example, when the browser window is resized and this forces adjustments in the appearance of the page, namely the size of subwindows, frames and the like. Reflow typically occurs in flow documents when new content is added, so existing content is automatically flowed around the new content. By restricting or preventing reflow of the stories in the document template, it can be said that the stories having variable content are fixed, in that they do not flow, even though their content is variable.

The customization information 245 may be personal, demographic, psychographic, behavioristic and other characteristics about a user, another person or some other entity (e.g., a business). These characteristics may be provided directly by the user, e.g., via a web form, and may be obtained directly or indirectly, such as by monitoring the user's activities or from databases. The customization information may take the form of keywords. The keywords may be selected or input directly by the user or may be obtained through analysis of characteristics such as those listed above. The characteristics themselves may include keywords. Keywords are stored in the content database 215 with relations to the content in the database, and in the relationship subsystem 235 with relations to the stories within the document template.

The system 200 may be used to create various kinds of printed documents, such as brochures and forms. For example, if custom brochures for a new car were desired, the layout tool 220 could be used to design the brochure. The document template for the brochure might include several stories marked up to receive variable content—several photos of the car showing the front, back, side and oblique exterior which could be in different colors and feature/option/trim packages, interior photos of the dash board, photos of different accessories, text describing the same features of the car in different ways, text describing different ways to use the car, etc. The database tool 210 could be used to iteratively store this custom content in the content database 215. The relationship subsystem 235 would identify how to choose the variable content for each story and the location of each story to receive the selected variable content.

A person interested in the car might browse to a web site about the car, and directly or indirectly, knowingly or unknowingly, provide the web server with characteristics about them. Perhaps the user expresses an interest in a red car and that the user has a large dog. The web site might provide the user with an option to order a brochure, for example by mail. From the user's address, it can be determined the kind of weather the user experiences, such as snow. In response to the user's request, the web site provides the user's characteristics to the rendering system 240. The rendering system then produces the brochure for printing. This brochure might include images of the car in red, images with a dog in the car, and images of the car in snow. This new, custom fixed document may then be printed and mailed to the user. Through this customization, the user receives a brochure that has better selling power than a generic brochure.

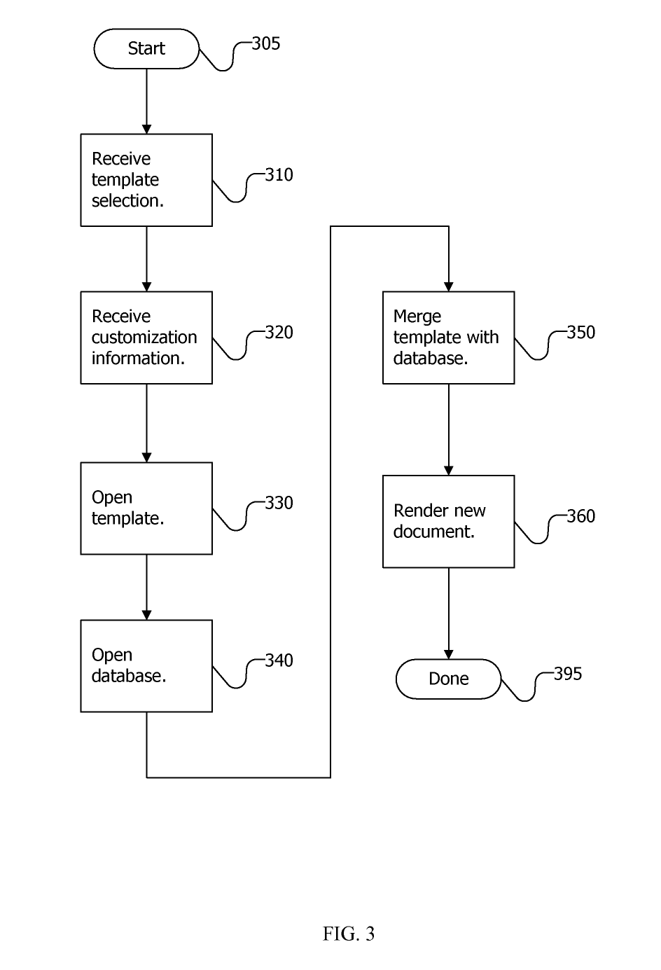

Referring now to FIG. 3 there is shown a flowchart of a process for personalized document creation in which a new, custom fixed document is rendered. The flow chart has both a start 305 and an end 395, but the process is cyclical in nature. The process of FIG. 3 may be performed by a rendering system such as the rendering system 240 of FIG. 2.

There may be several preparatory steps, in which one or more document templates are created, content is added into a content database, and relationship data defining relationships between respective stories on the one hand and selection criteria for variable content on the other hand. In these preparatory steps, the layout tool and the document contents management tool of FIG. 2 may be used as described above. Too, these preparatory steps may be included in the process for personalized document creation.

As a result of the preparatory steps, a content database, document templates and a relationship subsystem may be available to the rendering system. These may be the content database 215, the document templates 225 and the relationship subsystem 235 of FIG. 2. Assuming that the document templates, the content database and the relationship subsystem are available, the rendering system is ready to produce a new, custom fixed document.

In an early step, the rendering system may receive data for selecting one of the available document templates (step 310). This and other data may originate and be received as described above with respect to FIG. 2. The rendering system may also receive the customization information which will be used to select the variable content from the content database for customization of the selected document template (step 320). The identification of the template selection and the customization information may be received separately or in a single message, and may be via a direct or indirect user input. One or more pointers or identifiers may be passed to the rendering system so that the rendering system can retrieve the template selection information and the customization information.

The rendering system may then open the selected fixed document template (step 330) and open the content database (step 340), unless they are already open. It may also be necessary to open the relationship subsystem, for example if it is a database.

The rendering system may then merge the selected document template with the content database using the customization information (step 350). The document template may have one or more stories marked up for variable content. As explained above, content from the content database which is merged into the document template may be text, image, or both. This new content is disposed within or as the stories of the fixed document template. The content is selected from the content database using the selection criteria in the relationship subsystem and based upon the customization information. Thus, the customization information dictate custom qualities to be reflected in the new, custom fixed document. To select the variable content, the customization information may be first converted to keywords, so that the selection algorithm may be efficiently utilized. Alternatively, the selection algorithm may process customization information without conversion.

Next, the rendering system may render the new, custom fixed document with the layout from the fixed document template and the merged content (step 360). If the document template has only structure and is devoid of content, then static content may be imported into the fixed document template as directed by the static content markup. The resulting document includes the merged content disposed in the story without reflow.

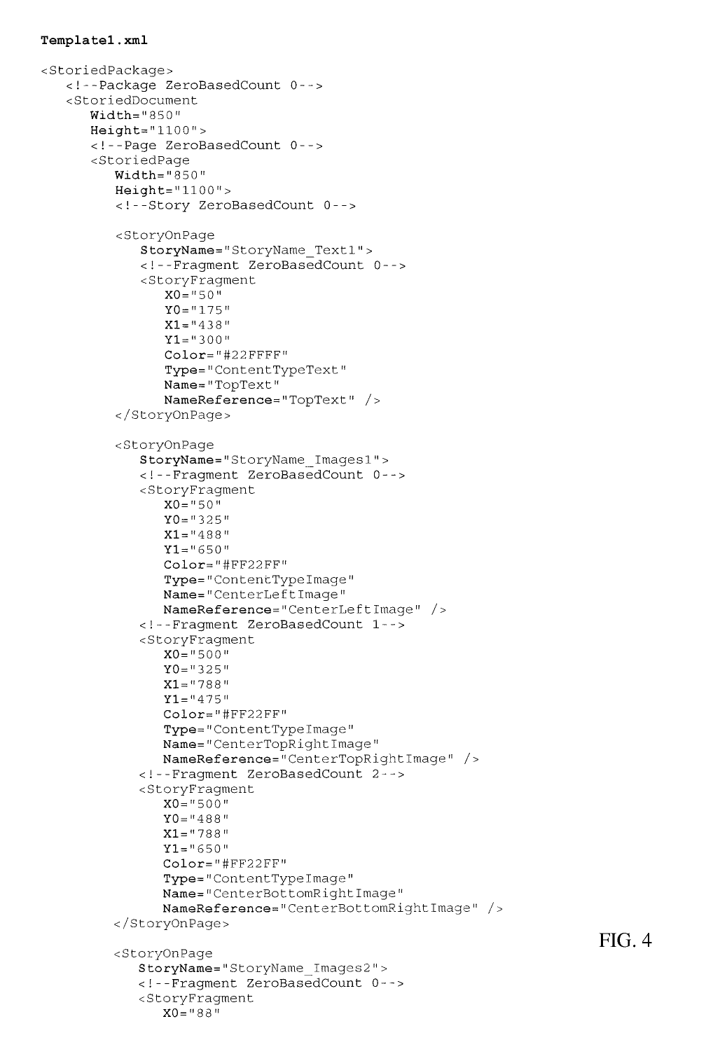

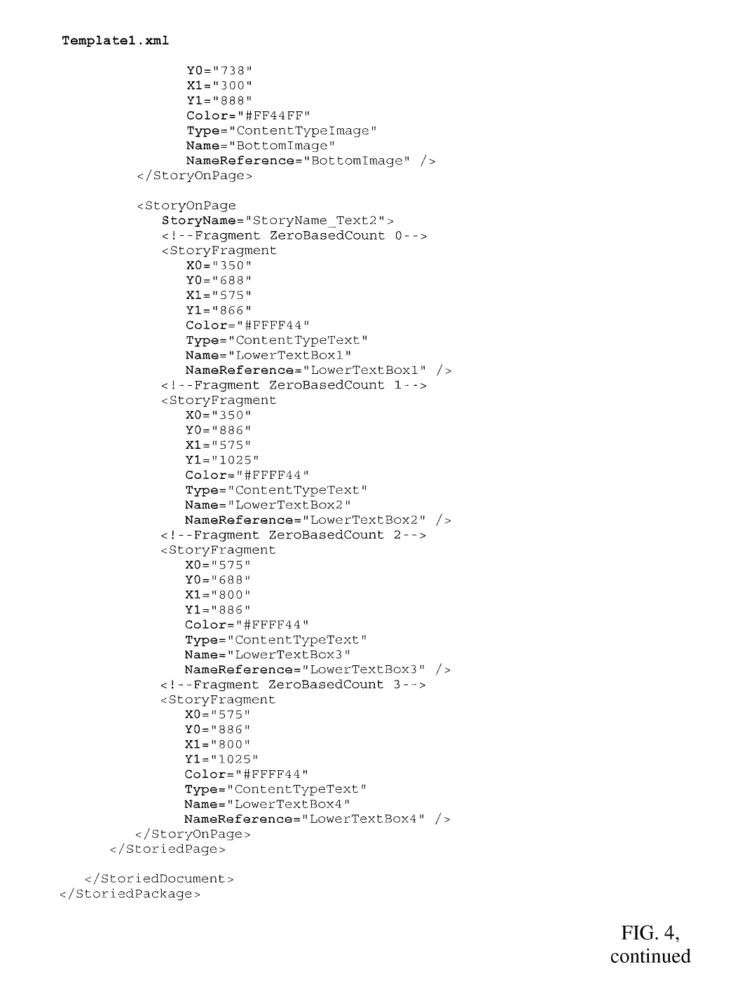

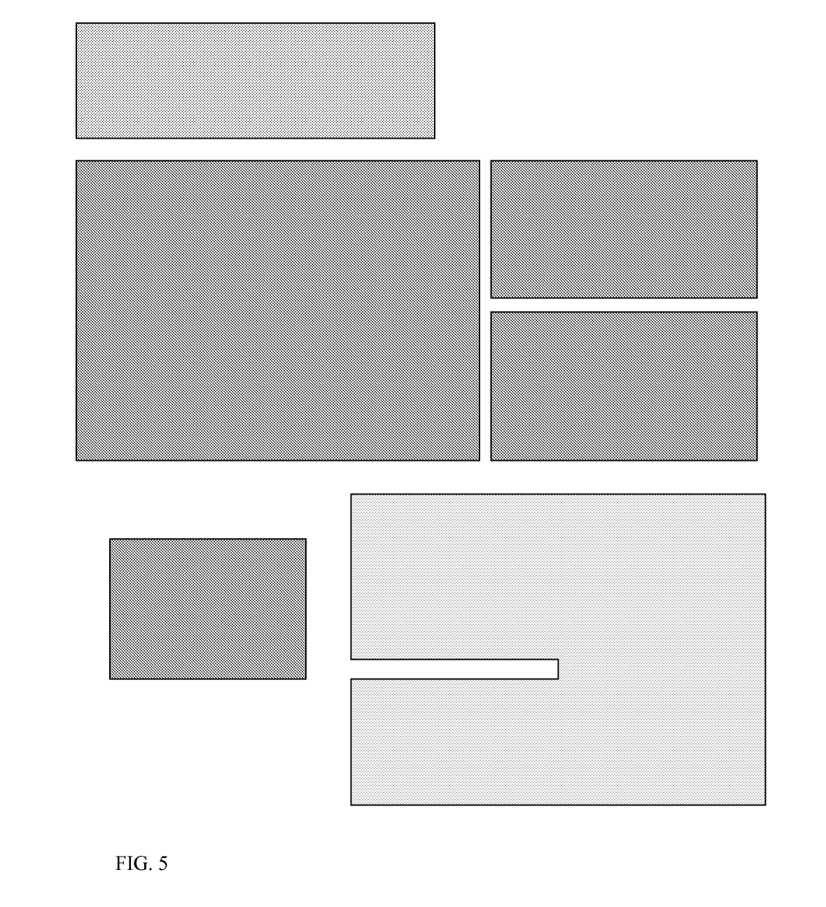

Referring now to FIG. 4 there is shown a sample of an XPS-formatted document template. FIG. 5 shows the appearance of the document template of FIG. 4.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

For means-plus-function limitations recited in the claims, the means are not intended to be limited to the means disclosed herein for performing the recited function, but are intended to cover in scope any means, known now or later developed, for performing the recited function.

As used herein, “plurality” means two or more.

As used herein, a “set” of items may include one or more of such items.

As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

As used herein, “and/or” means that the listed items are alternatives, but the alternatives also include any combination of the listed items.

It is claimed:

1. A process for rendering a new, custom fixed document comprising
opening a fixed document template, the fixed document template comprising a layout for a finished document, the layout including
markup for static content
at least one story marked up to receive variable content comprising at least one of text and image
merging variable content into the story of the fixed document template based upon a relationship between keywords corresponding to custom characteristics and the story, wherein the custom characteristics dictate custom qualities to be reflected in the new, custom fixed document
rendering the new, custom fixed document with the layout from the fixed document template and the merged content, wherein the merged content is disposed in the story without reflow.

2. The process of claim 1 wherein
the fixed document template has only structure and is devoid of content.

3. The process of claim 2 wherein the fixed document template is marked up to received static content.

4. The process of claim 3 further comprising
inserting static content into the fixed document template as directed by the static content markup.

5. The process of claim 1 further comprising
receiving the custom characteristics from a user input and determining keywords corresponding to the custom characteristics.

6. The process of claim 1 further comprising
receiving one or more keywords corresponding to one or more custom characteristics received from a user input.

7. The process of claim 1 further comprising
opening a database of text and images available for use as variable content, the database further including keywords respectively relating to the text and the images,
the merging step comprises merging the database with the fixed document template.

8. The process of claim 1 wherein the keywords are keys.

9. The process of claim 1 wherein the story comprises a passage of at least one of text and graphic content positioned within a defined region within a single page or spanning multiple pages.

10. A rendering system for rendering new, custom fixed documents, the rendering system comprising
a user input device
a display device
a processor
a memory
wherein the processor and the memory comprise circuits and software for
opening a fixed document template, the fixed document template comprising a layout for a finished document, the layout including
markup for static content
at least one story marked up to receive variable content comprising at least one of text and image
merging variable content into the story of the fixed document template based upon a relationship between keywords corresponding to custom characteristics and the story, wherein the custom characteristics dictate custom qualities to be reflected in the new, custom fixed document
rendering the new, custom fixed document with the layout from the fixed document template and the merged content, wherein the merged content is disposed in the story without reflow.

11. The rendering system of claim 10 wherein
the fixed document template has only structure and is devoid of content.

12. The rendering system of claim 11 wherein the fixed document template is marked up to received static content.

13. The rendering system of claim 12, the circuits and software further for
inserting static content into the fixed document template as directed by the static content markup.

14. The rendering system of claim 10, the circuits and software further for
receiving the custom characteristics from a user input and determining keywords corresponding to the custom characteristics.

15. The rendering system of claim 10, the circuits and software further for
receiving one or more keywords corresponding to one or more custom characteristics received from a user input.

16. The rendering system of claim 10, the circuits and software further for
opening a database of text and images available for use as variable content, the database further including keywords respectively relating to the text and the images,
the merging step comprises merging the database with the fixed document template.

17. The rendering system of claim 10 wherein the keywords are keys.

18. The rendering system of claim 10 wherein the story comprises a passage of at least one of text and graphic content positioned within a defined region within a single page or spanning multiple pages.

19. A machine readable storage medium having instructions stored thereon which when executed by a processor will cause the processor to perform actions comprising:
opening a fixed document template, the fixed document template comprising a layout for a finished document, the layout including
markup for static content
at least one story marked up to receive variable content comprising at least one of text and image
merging variable content into the story of the fixed document template based upon a relationship between keywords corresponding to custom characteristics and the story, wherein the custom characteristics dictate custom qualities to be reflected in the new, custom fixed document
rendering the new, custom fixed document with the layout from the fixed document template and the merged content, wherein the merged content is disposed in the story without reflow.

20. The machine readable storage medium of claim 19 wherein
the fixed document template has only structure and is devoid of content.

21. The machine readable storage medium of claim 20 wherein the fixed document template is marked up to received static content.

22. The machine readable storage medium of claim 21, the actions further comprising
inserting static content into the fixed document template as directed by the static content markup.

23. The machine readable storage medium of claim 22, the actions further comprising
receiving the custom characteristics from a user input and determining keywords corresponding to the custom characteristics.

24. The machine readable storage medium of claim 19, the actions further comprising
receiving one or more keywords corresponding to one or more custom characteristics received from a user input.

25. The machine readable storage medium of claim 19, the actions further comprising
opening a database of text and images available for use as variable content, the database further including keywords respectively relating to the text and the images,
the merging step comprises merging the database with the fixed document template.

26. The machine readable storage medium of claim 19 wherein the keywords are keys.

27. The machine readable storage medium of claim 19 wherein the story comprises a passage of at least one of text and graphic content positioned within a defined region within a single page or spanning multiple pages.
